(19) United States
(12) Patent Application Publication
(10) Pub. No.: US 2010/0209116 A1
(43) Pub. Date: Aug. 19, 2010

(54) OPTICAL TRANSMISSION SYSTEM, OPTICAL END TERMINAL EQUIPMENT, AND OPTICAL REPEATER EQUIPMENT

(75) Inventor: Kenta NODA, Yokohama (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/631,089

(22) Filed: Dec. 4, 2009

(30) Foreign Application Priority Data
Feb. 13, 2009 (JP) 2009-030636

(51) Int. Cl. H04B 10/00

(52) U.S. Cl. 398/165

(57) ABSTRACT

The present invention easily provides a network with high stability by setting a transmission rate without using a supervisory network in an optical repeater transmission system that uses multi-rate transponders. When setting a transmission rate of a multi-rate transponder, a rate changing data pattern is transmitted to a main signal to easily realize transmission rate setting for opposed equipment in an optical repeater transmission system through transmission and reception of the setting information.

### CLAIM OF PRIORITY

The present application claims priority from Japanese patent application serial no. 2009-030636, filed on Feb. 13, 2009, the content of which is hereby incorporated by reference into this application.

### BACKGROUND OF THE INVENTION

The present invention relates to an optical transmission system, optical end terminal equipment, and optical repeater equipment for plural different signal rates in optical transmission, and particularly to an optical transmission system, optical end terminal equipment, and optical repeater equipment for setting an optical signal rate of one optical signal converting unit.

As an optical converting unit of an optical transmission system, a multi-rate transponder corresponding to various interfaces has already been put to practical use. The multi-rate transponder performs rate setting in accordance with a transmission interface used for each wavelength converting unit, or performs transmission in accordance with a transmission rate of an input signal using a variable frequency filter and the like in a state where the transmission rate is unset.

In the transponder for separately setting a transmission rate in accordance with a transmission interface, the rate is directly set in transmission equipment where the transponder is disposed, or an optical supervisory channel (OSC) network is preliminarily established for remote transmission equipment to perform transmission rate setting for the transponder of each piece of equipment through the OSC network.

In the transponder where transmission is performed in accordance with a signal rate of an input signal using the variable frequency filter, it is possible to change a following rate by changing an interface. However, for monitoring such as detection of a frequency difference between input signals, it is necessary to register transmission rates through the OSC network.

Japanese Patent Application Laid-Open No. H5-292038 proposes a method, as the OSC network in an optical transmission system, of remotely performing supervisory control using an optical wavelength different from that of a main signal.

In the method described in Japanese Patent Application Laid-Open No. H5-292038, it is obvious that the necessity of another interface for performing supervisory control affects the cost of the system.

When performing transmission rate setting for an optical signal converting unit, it is necessary that the signal rate can be easily changed, and fluctuations in signal frequencies are monitored by setting the signal rates for the respective pieces of equipment.

When performing rate setting for the multi-rate transponder of the optical transmission system, it is necessary to perform the rate setting by transmitting and receiving a special data pattern for setting a transmission rate in the opposed equipment.

### SUMMARY OF THE INVENTION

According to the present invention, there is provided an optical transmission system including: a first terminal and a second terminal; first equipment, second equipment, and third equipment which are disposed between the first terminal and the second terminal; and optical transmission paths, wherein the first equipment includes: a first signal rate controlling unit which generates a first data pattern; a first transmission unit which transmits the first data pattern to the optical transmission path; and a first reception unit which receives an optical signal from the first terminal and an acknowledge signal for the first data pattern from the second equipment, the first signal rate controlling unit generates a second data pattern for a signal rate change on the basis of the acknowledge signal, and the first transmission unit further transmits the second data pattern to the optical transmission path, the second equipment includes: a second reception unit which receives the first data pattern transmitted from the first equipment; and a second transmission unit which transmits the acknowledge signal on the basis of the first data pattern, and the third equipment includes: a third reception unit which receives the first data pattern and the second data pattern; and a third transmission unit which transmits the first data pattern and the second data pattern.

In an optical repeater transmission method according to the present invention, the signal is transmitted to the opposed client equipment via other optical end terminal equipment through optical end terminal equipment which receives an optical signal from client equipment for signal processing and then, transmits the signal to the transmission path side, or receives an optical signal from the transmission path side for signal processing and then, transmits the signal to client equipment, and through optical repeater equipment which receives a signal from the transmission path side for signal processing and then, transmits the signal the transmission path side different from the reception side; signal converting units of the optical end terminal equipment and the optical repeater equipment are provided with a function of changing a signal rate; the signal rate is set from one piece of optical end terminal equipment or optical repeater equipment; and rate setting for the remote optical end terminal equipment or the optical repeater equipment is performed at a time.

According to the present invention, a control signal is transmitted to the opposed optical end terminal equipment or optical repeater equipment, the optical end terminal equipment and the optical repeater equipment sets a transmission rate on the basis of the received control signal, so that it is possible to easily change a signal rate. Further, by setting signal rates for the respective pieces of equipment, it is possible to monitor fluctuations in signal frequencies. Furthermore, a special data pattern used for setting a transmission rate of a transponder is transmitted to a main signal in the opposed multi-rate transponder, so that it is possible to perform transmission rate setting in accordance with an interface used. It is possible to easily and economically perform rate setting without control using a controlling network for setting a rate for the opposed transponder or without control using a different wavelength.

### BRIEF DESCRIPTION OF THE DRAWINGS

FIG. 1 is a diagram for showing an optical transmission system;

FIG. 2 is a diagram for showing a configuration of optical end terminal equipment;

FIG. 3 is a diagram for showing a configuration of optical repeater equipment;

FIG. 4 is a flow diagram of a transmission rate changing sequence from the optical end terminal equipment; and

FIG. 5 is a flow diagram of a transmission rate changing sequence from the optical repeater equipment.

### DETAILED DESCRIPTION OF THE EMBODIMENT

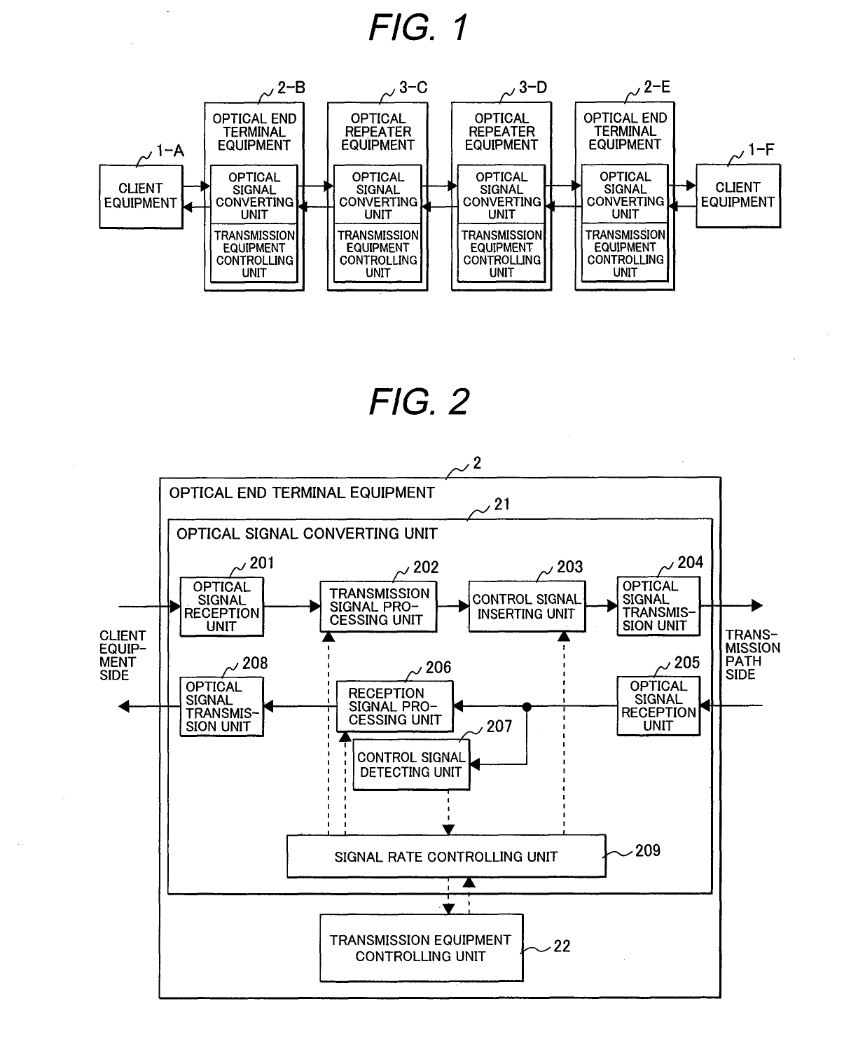

Hereinafter, an embodiment will be described in detail. FIG. 1 is a diagram for showing a configuration of an optical repeater transmission system to which the present invention is applied. The system shown in FIG. 1 connects client equipment (terminal) 1-A and client equipment (terminal) 1-F which are disposed at two separate points. Optical end terminal equipment 2-B for the client equipment 1-A performs data transmission to the client equipment 1-F through optical end terminal equipment 2-E via plural repeaters such as optical repeater equipment 3-C and optical repeater equipment 3-D. The number of pieces of optical repeater equipment 3 may be 0 if not used, or may be an arbitrary number (one or larger) in accordance with system requirements. It. should be noted that the respective pieces of equipment 1, 2 and 3 are connected to each other through optical transmission paths (not shown).

FIG. 2 is a detailed block diagram of the optical end terminal equipment. The optical end terminal equipment 2 receives an optical signal from the client equipment 1, and transmits the optical signal to the transmission path side. The optical end terminal equipment 2 includes an optical signal converting unit 21 and a transmission equipment controlling unit 22. The optical signal converting unit 21 includes an optical signal reception unit 201, a transmission signal processing unit 202, a control signal inserting unit 203, an optical signal transmission unit 204, an optical signal reception unit 205, a reception signal processing unit 206, a control signal detecting unit 207, and a signal rate controlling unit 209.

The optical signal converting unit 21 receives an optical signal from the transmission path side, and transmits the optical signal to the client equipment 1. The transmission equipment controlling unit 22 controls the optical signal converting unit 21.

The optical signal reception unit 201 receives the optical signal from the client equipment. The transmission signal processing unit 202 generates a signal to be transmitted to the transmission path side. The control signal inserting unit 203 transmits a control signal to the opposed equipment. The optical signal transmission unit 204 converts an electric signal to an optical signal to be transmitted to the transmission path. The optical signal reception unit 205 receives an optical signal from the transmission path side.

The reception signal processing unit 206 passes on a received signal to the client equipment. The control signal detecting unit 207 retrieves control information from the received signal. The optical signal transmission unit 208 which transmits an optical signal to the client equipment and the signal rate controlling unit 209 transmit information of a signal rate to the transmission path side in accordance with the control information from the control signal detecting unit 207 or the transmission equipment controlling unit 22. The signal rate controlling unit 209 also performs transmission rate setting for the transmission signal processing unit 202 and the reception signal processing unit 206.

The transmission equipment controlling unit 22 of the optical end terminal equipment 2 sets a first transmission rate in accordance with the client equipment 1. At the time of setting, the transmission equipment controlling unit 22 transmits a transmission rate control command to the signal rate controlling unit 209. The signal rate controlling unit 209 controls the control signal inserting unit 203 on the basis of the setting, and stops data transmission from the transmission signal processing unit 202. The signal rate controlling unit 209 further generates and transmits a rate setting data pattern.

As the rate setting data pattern, a data pattern which is not used in normal signal transmission is used. Ethernet uses 8B10B coding. However, there is a data pattern that is not generated by the 8B10B coding rule and it is referred to as the rate setting data pattern. As a result, it is possible to be discriminated from a normal data signal.

The optical signal transmission unit 204 transmits the rate setting data pattern to the transmission path side. The control signal detecting unit 207 monitors the data pattern received by the optical signal reception unit 205. When detecting an ACK signal for the rate setting from the transmission path side, the control signal detecting unit 207 passes on the same to the signal rate controlling unit 209. The signal rate controlling unit 209 converts the rate setting data pattern inserted into the control signal inserting unit 203 into a rate change executing data pattern for transmission. Thereafter, the signal rate controlling unit 209 performs rate setting for the transmission signal processing unit 202 and the reception signal processing unit 206. The control signal inserting unit 203 allows the data from the transmission signal processing unit 202 to pass through. It should be noted that as the rate change executing data pattern, a data pattern which is not used in normal signal transmission is used, as similar to the rate setting data pattern.

Further, in the case where the rate setting is performed from the opposed optical end terminal equipment, the control signal detecting unit 207 detects a special data pattern used for performing the rate setting. The signal rate controlling unit 209 generates an ACK signal for the opposed equipment to be transmitted to the opposed optical end terminal equipment through the control signal inserting unit 203. The control signal detecting unit 207 detects the rate change executing data pattern. The signal rate controlling unit 209 performs the rate setting for the transmission signal processing unit 202 and the reception signal processing unit 206.

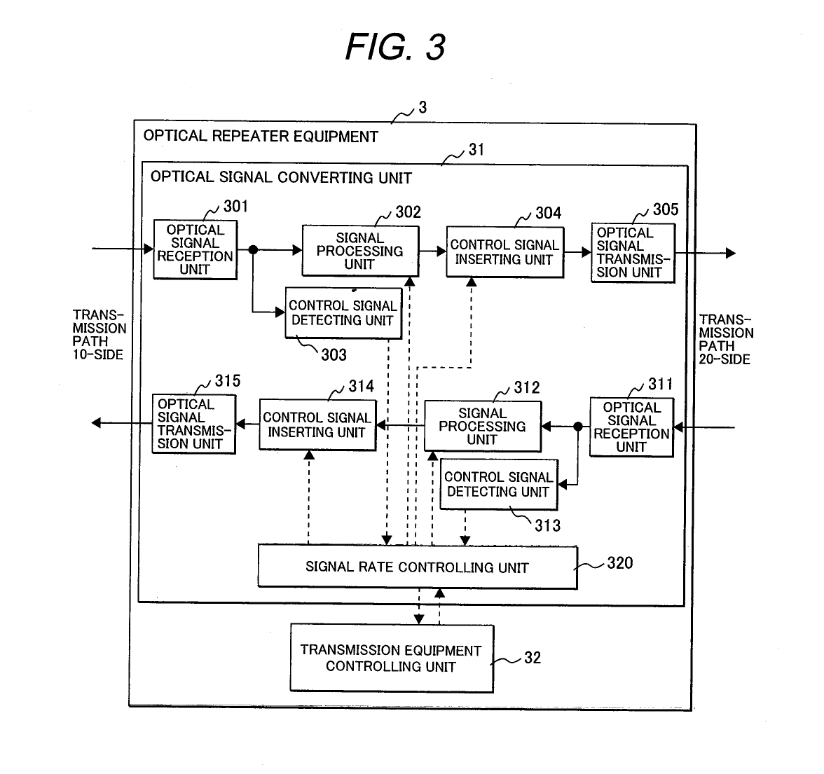

FIG. 3 is a detailed block diagram of the optical repeater equipment. The optical repeater equipment has two transmission path interfaces, and transmission paths to which the respective interfaces are connected are referred to as a transmission path 10 and a transmission path 20. The optical repeater equipment 3 includes an optical signal converting unit 31, and a transmission equipment controlling unit 32. The optical signal converting unit 31 includes an optical signal reception unit 301, a signal processing unit 302, a control signal detecting unit 303, a control signal inserting unit 304, an optical signal transmission unit 305, an optical signal reception unit 311, a signal processing unit 312, a control signal detecting unit 313, a control signal inserting unit 314, an optical signal transmission unit 315, and a signal rate controlling unit 320.

The optical signal converting unit 31 receives an optical signal from the transmission path 10-side, and transmits the optical signal to the transmission path 20-side. The optical signal converting unit 31 also receives an optical signal from the transmission path 20-side, and transmits the optical signal to the transmission path 10-side. The transmission equipment controlling unit 32 controls the optical signal converting unit.

The optical signal reception unit 301 receives an optical signal from the transmission path 10-side. The signal processing unit 302 generates a signal to be transmitted to the transmission path 20-side. The control signal detecting unit 303 retrieves control information from a received signal, and transmits a control signal to the opposed equipment on the transmission path 20-side. The optical signal transmission unit 305 converts an electric signal into an optical signal to be transmitted to the transmission path 20. The optical signal reception unit 311 receives an optical signal from the transmission path 20-side.

The signal processing unit 312 generates a signal to be transmitted to the transmission path 10-side. The control signal detecting unit 313 retrieves control information from a received signal. The control signal inserting unit 314 transmits a control signal to the opposed equipment on the transmission path 20-side. The optical signal transmission unit 315 converts an electric signal into an optical signal to be transmitted to the transmission path 10. The signal rate controlling unit 320 transmits information of a signal rate to the transmission path side in accordance with the control information from the control signal detecting units 303 and 313, or the transmission equipment controlling unit 32. The signal rate controlling unit 320 also performs transmission rate setting for the signal processing units 302 and 312.

The transmission equipment controlling unit 32 sets a transmission rate, as similar to the optical end terminal equipment 1. The signal rate controlling unit 320 controls the control signal inserting units 304 and 314 on the basis of the setting to stop data from the signal processing units 302 and 312. The signal rate controlling unit 320 generates and transmits the rate setting data pattern. The optical signal transmission units 305 and 315 transmit the rate setting data patterns to the transmission path 10-side and the transmission path 20-side. The control signal detecting units 303 and 313 monitor the data patterns received by the optical signal reception units 301 and 311. When detecting an ACK signal for the rate setting from the transmission path 10-side or the transmission path 20-side, the control signal detecting units 303 and 313 pass on the same to the signal rate controlling unit 320. When receiving the ACK signals from the both directions, the signal rate controlling unit 320 performs the rate setting for the signal processing units 302 and 312. The signal rate controlling unit 320 stops the rate setting data patterns inserted into the control signal inserting units 304 and 314. The signal rate controlling unit 320 allows the data from the signal processing units 302 and 312 to pass through, so that the transmission rate is set.

Further, there will be described a case in which, as the rate setting from the opposed optical end terminal equipment or the opposed optical repeater equipment, the special data patterns (the rate setting data pattern and rate change executing data pattern) used for changing a signal rate are received from the equipment on the transmission path 10-side. The special data patterns used for performing the rate setting from the transmission path 10-side are transmitted from the optical signal transmission unit 305 to the transmission path 20-side through the optical signal reception unit 301, the signal processing unit 302, and the control signal inserting unit 304. Further, only an idle signal is transmitted while stopping data transfer during a period from the time the control signal detecting unit 303 detects the special data patterns to the time an ACK signal for notifying a signal rate change is transmitted to the transmission path 10-side by the control signal inserting unit 314. After an ACK signal related to the rate change is received from the transmission path 20-side by the control signal detecting unit 313 through the optical signal reception unit 311, a new ACK signal is generated by the signal rate controlling unit 320 to be transmitted to the equipment on the transmission path 10-side through the control signal inserting unit 314. After receiving the rate change executing data pattern from the transmission path 10-side, the rate setting is newly performed for the signal processing units 302 and 312, and data from the transmission signal processing unit is allowed to pass through.

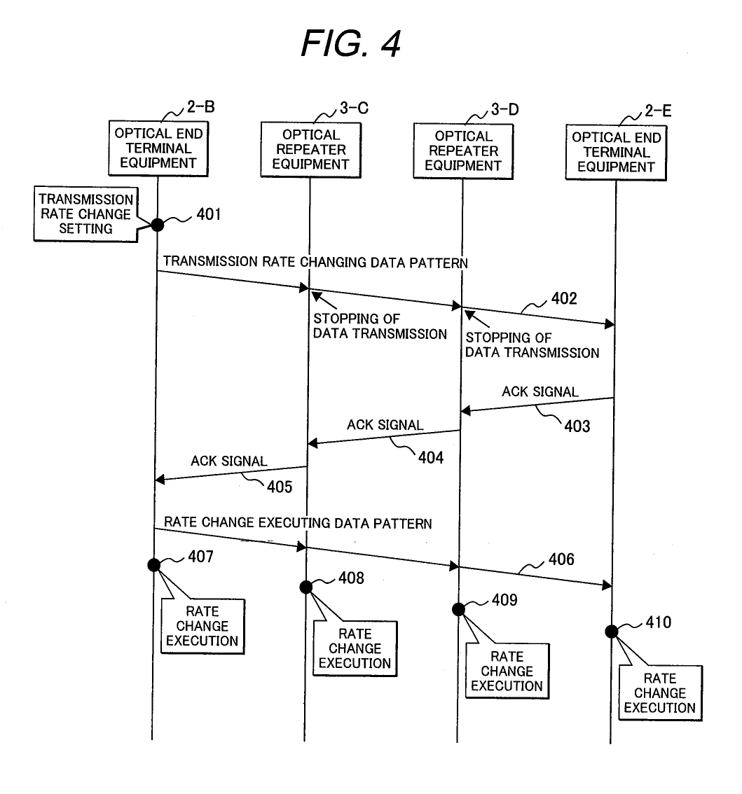

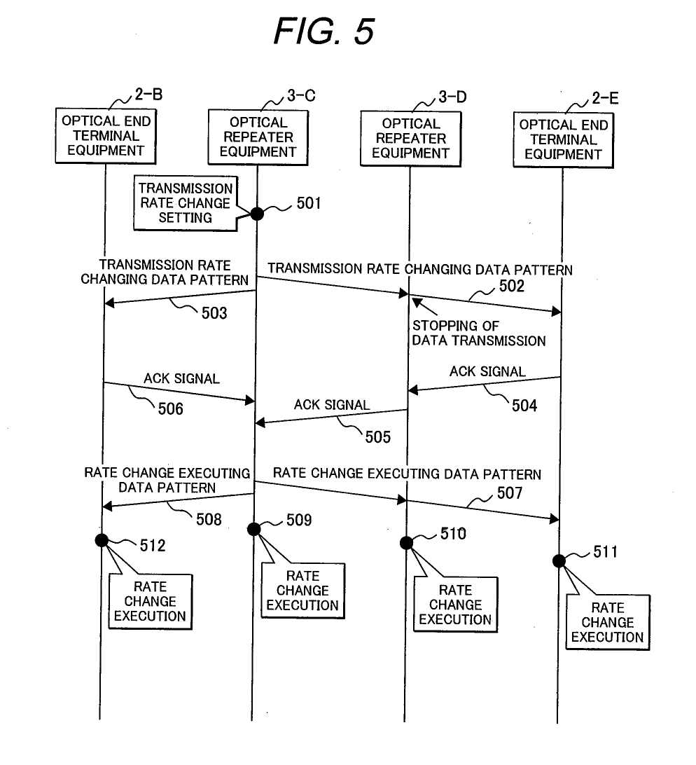

FIG. 4 is a sequence diagram for performing transmission rate change setting from the optical end terminal equipment. The optical end terminal equipment 2-B transmits a transmission rate changing data pattern 402 to the transmission path on the basis of transmission rate change setting 401. The optical repeater equipment pieces 3-C and 3-D which received the transmission rate changing data pattern allow the changing data pattern to pass through, and transmits an idle signal after stopping data transmission on the reception side. After receiving the transmission rate changing data pattern, the optical end terminal equipment 2-E transmits an acknowledge signal (ACK signal 403) for approving a signal rate change. The optical repeater equipment 3-D receives the ACK signal to generate an ACK signal 404 for approving the signal rate change, and transmits the same to the optical repeater equipment 3-C-side. The optical repeater equipment 3-C also transmits an ACK signal for approving the rate change to the optical end terminal equipment 2-B, as similar to the above. After receiving the ACK signal, the optical end terminal equipment 2-B transmits a rate change executing data pattern 406. The optical end terminal equipment 2-B also performs the rate change of itself (407). The optical repeater equipment 3-C detects the rate change executing data pattern 406, and performs the rate change (408). As similar to the above, the optical repeater equipment 3-D and the optical end terminal equipment 2-E detect the rate change executing data pattern to perform the rate change. As described above, the rate setting can be performed under control of one piece of optical end terminal equipment 2-B, so that it is possible to eliminate complicated operations such as rate setting for the respective pieces of equipment on the network.

FIG. 5 is a sequence diagram for performing transmission rate change setting from the optical repeater equipment. The optical repeater equipment 3-C transmits transmission rate changing data patterns 502 and 503 to the transmission paths in two directions on the basis of transmission rate change setting 501. The optical repeater equipment 3-D which received the transmission rate changing data pattern allows the changing data pattern to pass through, and transmits an idle signal after stopping data transmission on the reception side. After receiving the transmission rate changing data pattern, the optical end terminal equipment 2-E transmits an ACK signal 504 for approving a signal rate change. The optical repeater equipment 3-D receives the ACK signal to generate an ACK signal 505 for approving the signal rate change, and transmits the same to the optical repeater equipment 3-C-side. After receiving the transmission rate changing data pattern 503, the optical end terminal equipment 2-B transmits an ACK signal 506 for approving the signal rate change, as similar to the above. After receiving the ACK signals 505 and 506, the optical repeater equipment 3-C transmits rate change executing data patterns 507 and 508. The optical repeater equipment 3-C also performs a rate change of itself (509). The optical repeater equipment 3-D detects the rate change executing data pattern 507, and performs the rate change (510). The optical end terminal equipment pieces 2-B and 2-E detect the rate change executing data patterns and perform the rate change.

It should be noted that as the rate setting data pattern and the rate change executing data pattern, the same patterns as those in FIG. 4 may be used. Since the rate change setting can be performed from the optical repeater equipment, the rate can be set from any points on the network, thus, improving the efficiency of construction and maintenance of the network.

As described above, when a transmission rate is changed, the transmission rate changed data pattern is allowed to flow in a main signal, so that it is possible to set a rate for remote equipment without the necessity of a network for performing supervisory control. In order to change a rate which is a basic parameter in transmission, it is impossible to keep network synchronization and to perform error-free control. However, transmission of the data pattern to the main signal as described above involves no technical limitations, and thus, it is possible to provide a method of performing remote setting with a simple configuration.

As optical transmission equipment, there exist multi-rate transponders corresponding to various interfaces. In the case where rate setting is performed for the multi-rate transponders in accordance with each interface, it is possible to perform transmission rate setting for remote equipment without additionally establishing the OSC network.

What is claimed is:

1. An optical transmission system comprising:
a first terminal and a second terminal;
first equipment, second equipment, and third equipment which are disposed between the first terminal and the second terminal; and
optical transmission paths,
wherein the first equipment includes: a first signal rate controlling unit which generates a first data pattern; a first transmission unit which transmits the first data pattern to the optical transmission path; and a first reception unit which receives an optical signal from the first terminal and an acknowledge signal for the first data pattern from the second equipment, the first signal rate controlling unit generates a second data pattern for a signal rate change on the basis of the acknowledge signal, and the first transmission unit further transmits the second data pattern to the optical transmission path,
the second equipment includes: a second reception unit which receives the first data pattern transmitted from the first equipment; and a second transmission unit which transmits the acknowledge signal on the basis of the first data pattern, and
the third equipment includes: a third reception unit which receives the first data pattern and the second data pattern; and a third transmission unit which transmits the first data pattern and the second data pattern.

2. The optical transmission system according to claim 1,
wherein the first signal rate controlling unit stops communications of an optical signal from the first terminal, and generates the first data pattern.

3. The optical transmission system according to claim 1, further comprising a transmission equipment controlling unit for transmitting a transmission rate control command to the first signal rate controlling unit,
wherein the first signal rate controlling unit generates the first data pattern when receiving the transmission rate control command.

4. The optical transmission system according to claim 1,
wherein the second equipment further includes a second signal rate controlling unit, the third equipment further includes a third signal rate controlling unit, and each of the first signal rate controlling unit, the second signal rate controlling unit, and the third signal rate controlling unit controls a signal rate on the basis of the second data pattern.

5. The optical transmission system according to claim 1,
wherein the first equipment is first optical end terminal equipment which communicates with the first terminal, the second equipment is second optical end terminal equipment which communicates with the second terminal, and the third equipment is optical repeater equipment.

6. The optical transmission system according to claim 1,
wherein the first equipment is first optical repeater equipment, the second equipment is first optical end terminal equipment which communicates with the first terminal, and the third equipment is second optical repeater equipment.

7. The optical transmission system according to claim 6, further comprising second optical end terminal equipment which communicates with the second terminal.

8. Optical end terminal equipment connected to a first terminal, a second terminal, optical repeater equipment, and other optical end terminal equipment through optical transmission paths, the optical end terminal equipment comprising:
a first signal rate controlling unit which generates a first data pattern;
a first transmission unit which transmits the first data pattern to the other optical end terminal equipment through the optical repeater equipment; and
a first reception unit which receives an optical signal from the first terminal, and an acknowledge signal for the first data pattern from the other optical end terminal equipment,
wherein the first signal rate controlling unit generates a second data pattern for changing a signal rate on the basis of the acknowledge signal, and the first transmission unit further transmits the second data pattern to the other optical end terminal equipment through the optical repeater equipment.

9. The optical end terminal equipment according to claim 8,
wherein the first signal rate controlling unit controls a signal rate on the basis of the second data pattern.

10. The optical end terminal equipment according to claim 8, further comprising a transmission signal processing unit for processing an optical signal from the first terminal,
wherein the transmission signal processing unit transmits the optical signal from the first terminal after the first signal rate controlling unit controls the signal rate on the basis of the second data pattern.

11. Optical repeater equipment connected to a first terminal, a second terminal, and first optical end terminal equipment through optical transmission paths, the optical repeater equipment comprising:
a first signal rate controlling unit which generates a first data pattern;
a first transmission unit which transmits the first data pattern to the optical transmission path; and
a first reception unit which receives an acknowledge signal for the first data pattern from the first optical end terminal equipment,
wherein the first signal rate controlling unit generates a second data pattern for changing a signal rate on the basis of the acknowledge signal, and the first transmission unit further transmits the second data pattern to the optical transmission path.

12. The optical repeater equipment according to claim 11,
wherein the first signal rate controlling unit controls a signal rate on the basis of the second data pattern.
